(19) United States
(12) Patent Application Publication
(10) Pub. No.: US 2015/0094252 A1
(43) Pub. Date: Apr. 2, 2015

(54) FIBROUS STRUCTURES CONTAINING SURFACTANTS AND METHODS FOR MAKING THE SAME

(71) Applicant: The Procter & Gamble Company, Cincinnati, OH (US)

(72) Inventors: Oscar Augusto Cuyubamba, Cincinnati, OH (US); Michael Scott Prodoehl, West Chester, OH (US); Fei Wang, Mason, OH (US); Steven Lee BARNHOLTZ, West Chester, OH (US); Michael Donald SUER, Colerain Township, OH (US); Timothy Duane SMITH, Lebanon, OH (US)

(21) Appl. No.: 14/494,760

(22) Filed: Sep. 24, 2014

Related U.S. Application Data
(60) Provisional application No. 61/883,421, filed on Sep. 27, 2013.

(51) Int. Cl. C11D 17/04; C11D 17/00

(52) U.S. Cl. CPC C11D 17/046; C11D 17/003
USPC 510/404; 510/441

(57) ABSTRACT

A dry-to-the-touch fibrous structure containing a surfactant paste composition, surfactant paste composition used therewith, and methods for making same are provided.

### FIELD OF THE INVENTION

The present invention relates to fibrous structures, more particularly to novel fibrous structures that comprise a surfactant, for example a surfactant paste composition, surfactant paste compositions used therewith, and methods for making same.

### BACKGROUND OF THE INVENTION

Fibrous structures comprising surfactants are known in the art. For example, a prior execution by Applicants included creating high viscosity (greater than 2000 cps) surfactant pastes by reducing the free water level in the surfactant pastes such that the surfactant pastes goes through a major rheological transition as it is dried (water level is reduced) from a “wet” flowable paste to a low-moisture, highly viscous surfactant paste. These low-moisture, highly viscous surfactant pastes are designed to inhibit penetration into a substrate to which surfactant pastes are applied. Such high viscosity surfactant pastes are problematic to apply during the process for making fibrous structures.

As alternatives to the high viscosity surfactant paste executions, the use of aqueous cleaning solutions with dry fibrous structures, such as paper towels, is commonplace. However, whether a consumer is combining a cleaner with a paper towel or a manufacturer is providing a 2-in-1 product (a paper towel comprising an aqueous solution of surfactants), these structures often fail to provide adequate suds and cleaning performance. Indeed, consumers often desire a range of suds different than what is provided by known products. In other words, consumers are looking for the right amount of suds at the right time. A lack of suds signals to consumers that more product is necessary to achieve the desired level of cleaning and an over abundance of suds necessitates rinsing the dish or surface being cleaned. Moreover, known products and/or use of towels with cleaners often fail to satisfactorily remove grease or dirt, while leaving soap and other residue on the surface.

One common prior art execution includes formulators utilizing aqueous solutions of surfactants. They have achieved these aqueous solutions of surfactants by diluting surfactant pastes with water converting the surfactant pastes into aqueous solutions of surfactants as a result of the high water level added to the surfactant pastes.

Even though surfactant pastes are known in the art and are often an intermediate step in the process of making aqueous solutions of surfactants; namely formulators add free water to the surfactant pastes to reduce their viscosities to permit them to be more pumpable/flowable, manufacturers have tended to apply the aqueous solutions of surfactants to fibrous structures.

Further, manufacturers use a cumbersome process to create dry-to-the-touch 2-in-1 products. Aqueous liquid soaps, surfactants or other aqueous cleaning solutions are applied to a fibrous structure, and then the fibrous structure is dried to remove the excess free water present in the aqueous solutions. Moreover, manufacturers face microbial growth, storage stability, discoloration as a result of oxidation of the surfactants, and increased processability and/or manufacturing issues due to having to dry the wet substrates before packaging.

For example, formulators to date have applied aqueous solutions of surfactants to dry substrates. Such application of aqueous solutions to paper towels creates issues with the loss of tensile strength in the paper towels and the need to dry the excess free water off the paper towels during the manufacturing process. In the past formulators have added water to a surfactant paste to create an aqueous solution of the surfactants prior to applying the aqueous solution of surfactants to the dry substrates.

One problem faced by formulators as described above is how to make a dry-to-the-touch fibrous structure that comprises a surfactant paste impregnated in a substrate, such as a paper towel, such that the surfactants are readily accessible to produce suds with no or minimal agitation and/or mechanical manipulation upon contact with water, that requires no drying step during manufacturing, and that inhibits discoloration of the fibrous structure during storage.

Therefore, there is a need for a dry-to-the-touch product infused with a surfactant paste and/or cleaning composition comprising a surfactant paste (such as a paper towel product having a surfactant paste and/or cleaning composition comprising a surfactant paste) that has adequate initial and going suds. There is also a need for a dry-to-the-touch product having a surfactant paste and/or cleaning composition comprising a surfactant paste that exhibits better cleaning (e.g., grease removal) than what is known. There is a further need for making such products that avoids the negatives of applying an aqueous solution to dry substrates, for example by applying a surfactant paste to the dry substrate. Further, there is a need for a dry-to-the-touch product having a surfactant paste and/or cleaning composition comprising a surfactant paste that leaves less residue on surfaces than known products. Further still, there is need for an efficient process for, and decreased manufacturing costs associated with, creating such a dry-to-the-touch product.

### SUMMARY OF THE INVENTION

The present invention addresses these needs by providing a dry-to-the-touch fibrous structure comprising a surfactant paste composition (for example a low moisture, low viscosity (less than 1000 cps) surfactant paste composition) suitable for dish and hard surface cleaning, surfactant paste compositions used herein, and a method for making such surfactant paste compositions and dry-to-the-touch fibrous structures comprising a surfactant paste composition, for example that avoids the need to add water to the surfactant paste to form an aqueous solution of the surfactants prior to applying the surfactants to the fibrous structure.

One solution to the problem identified above is to apply a surfactant paste composition, for example a low moisture, low viscosity surfactant paste composition, to a fibrous structure to make a dry-to-the-touch fibrous structure comprising a surfactant paste composition that avoids the negatives described above.

In one example of the present invention, a dry-to-the-touch fibrous structure comprising a surfactant paste composition, for example a surfactant paste composition comprising one or more, for example two or more surfactants, wherein the surfactant paste composition exhibits a viscosity of less than 1000 cps is provided.

In another example of the present invention, a dry-to-the-touch fibrous structure comprising a surfactant paste composition comprising one or more, for example two or more surfactants, and less than 30% by weight of free water is provided.

In another example of the present invention, a surfactant paste composition comprising one or more, for example two or more surfactants, wherein the surfactant paste composition exhibits a viscosity of less than 1000 cps is provided.

In another example of the present invention, a surfactant paste composition, for example comprising one or more, for example two or more surfactants, comprising less than 30% by weight of free water is provided.

In another example of the present invention, a surfactant paste composition, for example comprising one or more, for example two or more surfactants, comprising less that 30% by weight of free water and exhibits a viscosity of less than 1000 cps is provided.

In one embodiment, a dry-to-the-touch fibrous structure impregnated with a cleaning composition, for example a cleaning composition comprising one or more surfactants, such as a surfactant paste composition according to the present invention, comprising greater than about 3 gsm of the one or more surfactants, wherein the fibrous structure exhibits a Suds Retention Value of less than 55% as measured according to the Suds Volume Test Method described herein is provided.

In another embodiment, a dry-to-the-touch fibrous structure impregnated with a cleaning composition, for example a cleaning composition comprising one or more surfactants, such as a surfactant paste composition according to the present invention, exhibits an Initial Suds Volume of greater than about 40 mL and a Suds Retention Value of less than about 55% as measured according to the Suds Volume Test Method described herein is provided.

In a further embodiment, a dry-to-the-touch fibrous structure impregnated with a cleaning composition, for example a cleaning composition comprising one or more surfactants, such as a surfactant paste composition according to the present invention, exhibits an Initial Suds Volume of greater than about 60 mL and a Suds Retention Value of less than about 70% as measured according to the Suds Volume Test Method described herein is provided.

In yet another embodiment, a method for making a surfactant paste composition comprising the steps of:

a. providing a surfactant paste, for example a surfactant paste comprising one or more, for example two or more surfactants; and

b. adding to the surfactant paste one or more non-water viscosity reducing agents, for example one or more polyhydric alcohols, such as polyethylene glycol, such as a polyethylene glycol that exhibits a molecular weight of less than 500 g/mol, such that a surfactant paste composition is formed that exhibits one or more of the following properties:

i. a non-random crystal pattern;

ii. a viscosity of less than 1000 cps;

iii. less than 30% by weight of free water;

iv. no birefringence as measured according to the Crystallinity Test Method described herein; and

v. combinations thereof is provided.

In yet another embodiment, a method for making a surfactant paste composition comprises the steps of:

a. providing a surfactant paste, for example a surfactant paste comprising one or more, for example two or more surfactants; and

b. adding to the surfactant paste one or more additives selected from the group consisting of:
i. one or more additional surfactants;
ii. one or more non-water viscosity reducing agents, for example one or more polyhydric alcohols, for example polyethylene glycol; and
iii. mixtures thereof; such that a surfactant paste composition is formed that exhibits one or more of the following properties:

i. a non-random crystal pattern;

ii. a viscosity of less than 1000 cps;

iii. less than 30% by weight of free water;

iv. no birefringence as measured according to the Crystallinity Test Method described herein; and

v. combinations thereof is provided.

The crystal pattern can be observed as a simple arrangement of geometrical shapes, clear or amorphous, on a surface under a magnifying devise, e.g., optical microscope. The crystal pattern observed may show a typical surfactant arrangement described in literature or a new one governed by the principles of surfactant self-assembly.

In still another embodiment of the present invention, a method for making a dry-to-the-touch fibrous structure comprising a surfactant paste composition according to the present invention comprising the steps of:

a. providing a surfactant paste composition according to the present invention;

b. applying the surfactant paste composition to a fibrous structure to form the dry-to-the-touch fibrous structure is provided.

The present invention provides novel dry-to-the-touch fibrous structures, for example dry-to-the-touch fibrous structures comprising a surfactant paste composition, surfactant paste compositions, and methods for making same.

### DETAILED DESCRIPTION OF THE INVENTION

### Definitions

“Paste” as used herein means a material having a semi-solid form and/or comprising less than about 60% by weight of water. The paste may have a viscosity of 2000 centipoise (cps) or more.

“Surfactant paste” as used herein means a paste comprising one or more surfactants such as an anionic surfactant, amphoteric surfactant, cationic surfactant. In one example, the surfactant paste comprises an anionic surfactant, such as alkyl ethoxy sulfate surfactant, and/or an amphoteric surfactant, such as amine oxide surfactant, that is in a flowable solid state that does not continuously change its shape when subjected to a given yield stress. In one example, the surfactant paste exhibits a viscosity of 2000 cps or more.

Even though the addition of the polyhydric alcohol reduces the viscosity of the surfactant paste, it does not change the structure of the surfactant paste, in other words, it does not convert the surfactant paste into an aqueous solution of surfactants. The use of the polyhydric alcohol to reduce the viscosity of the surfactant paste avoids the negatives associated with using water to dilute the surfactant paste. The addition of water to the surfactant paste creates a random crystal pattern within the surfactant paste, creates a high water content surfactant paste that requires drying when applied to a dry substrate, and/or creates an undesirable middle phase. Surfactant mesophases are lyotropic, i.e., their structure is determined by specific interactions between the surfactant molecules. When the surfactant concentration in aqueous solution exceeds ˜10% by weight, micelle-micelle interactions become significant and the simple spherical structures generally undergo conversion first to infinite cylinders and then to multi-bilayers. The middle phase consists of surfactant molecules grouped into rod-like clusters of indefinite length that are arranged in a hexagonal packing arrangement comprising typically an oil-core, where the lipophilic groups form the core and hydrophilic groups lie on the surface; it exhibits optical birefringence (opalescence). Most surfactant/water systems are of this type. In the viscous isotropic phase, the molecules pack in spheres that then assemble into a face-centered or body-centered cubic lattice structure. A mesophase is an in-between, or intermediate, phase that exhibits certain aspects of both solid and liquid states while also possessing properties that are not found in either solids or liquids. For example, it has characteristic of crystals ((birefringence) and yet can flow like a liquid (liquid crystal) .

“Surfactant paste composition” as used herein means a composition comprising a surfactant paste and one or more non-water viscosity reducing agents. In one example, the surfactant paste composition comprises a polyhydric alcohol, for example polyethylene glycol, such as a PEG that exhibits a molecular weight of less than 500 and/or 400 or less and/or 300 or less and/or greater than 100 and/or about 200 or more. The addition of a polyhydric alcohol decreases the viscosity of the surfactant paste, which is typically around 2000 or more cps to less than 1000 cps and/or to less than 700 cps and/or to less than 500 cps to about 400 cps . In one example, the surfactant paste composition exhibits a viscosity of from about 50 to about 400 cps and/or from about 100 to about 400 cps. The surfactant paste compositions of the present invention do not include surfactant pastes that have been dried down by reducing the level of water/moisture in the pastes to less than 30% by weight of free water without adding a non-water viscosity reducing agent, for example a sufficient amount of a non-water viscosity reducing agent such that the viscosity falls to less than 1000 cps, because simply reducing the water level of the surfactant pastes creates a low moisture, high viscosity (greater than 1000 cps and/or greater than 1500 cps and/or greater than 2000 cps) surfactant paste that resists penetration into a fibrous structure.

Even though the addition of the polyhydric alcohol reduces the viscosity of the surfactant paste, it does not change the structure of the surfactant paste, in other words, it does not convert the surfactant paste into an aqueous solution of surfactants. The use of the polyhydric alcohol to reduce the viscosity of the surfactant paste avoids the negatives associated with using water to dilute the surfactant paste. The addition of water to the surfactant paste creates a random crystal pattern within the surfactant paste, creates a high water content surfactant paste that requires drying when applied to a dry substrate, and/or creates an undesirable middle phase. Surfactant mesophases are lyotropic, i.e., their structure is determined by specific interactions between the surfactant molecules. When the surfactant concentration in aqueous solution exceeds ˜10% by weight, micelle-micelle interactions become significant and the simple spherical structures generally undergo conversion first to infinite cylinders and then to multi-bilayers. The middle phase consists of surfactant molecules grouped into rod-like clusters of indefinite length that are arranged in a hexagonal packing arrangement comprising typically an oil-core, where the lipophilic groups form the core and hydrophilic groups lie on the surface; it exhibits optical birefringence (opalescence). Most surfactant/water systems are of this type. In the viscous isotropic phase, the molecules pack in spheres that then assemble into a face-centered or body-centered cubic lattice structure. A mesophase is an in-between, or intermediate, phase that exhibits certain aspects of both solid and liquid states while also possessing properties that are not found in either solids or liquids. For example, it has characteristic of crystals ((birefringence) and yet can flow like a liquid (liquid crystal).

“Aqueous solution of surfactants” as used herein and known in the art is a high water content composition comprising one or more surfactants. The aqueous solution of surfactants results from the addition of water to a surfactant paste that converts the structure of the surfactant paste into an aqueous solution of surfactants such that a paste no longer exists. Clearly this is different from adding a polyhydric alcohol, such as PEG 200, to a surfactant paste that does not result in the conversion of the structure of the surfactant paste (the structure of the surfactant paste is retained) into an aqueous solution of surfactants.

“Dry-to-the-touch” as used herein means a fibrous structure is substantially free of liquids such that it does not feel damp or wet prior to being subjected to water or other liquids. In one non-limiting example, a dry-to-the-touch fibrous structure has a water content of less than about 60%, or less than about 50%, or less than about 40%. The fibrous structures (e.g., sanitary tissue products) of the present invention remain dry-to-the-touch until they are moistened with water or other liquids.

“Fibrous structure” as used herein means a structure that comprises one or more filaments and/or fibers. In one example, a fibrous structure according to the present invention means an orderly arrangement of filaments and/or fibers within a structure in order to perform a function. Non-limiting examples of fibrous structures of the present invention include paper and fabrics (including woven, knitted, and non-woven).

Non-limiting examples of processes for making fibrous structures include known wet-laid papermaking processes and air-laid papermaking processes. Such processes typically include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous slurry is then used to deposit a plurality of fibers onto a forming wire or belt such that an embryonic fibrous structure is formed, after which drying and/or bonding the fibers together results in a fibrous structure. Further processing of the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g. a sanitary tissue product. The fibrous structure of the present invention may be embossed.

The fibrous structures of the present invention may be homogeneous or may be layered. If layered, the fibrous structures may comprise at least two and/or at least three and/or at least four and/or at least five layers.

The fibrous structures of the present invention may be co-formed fibrous structures.

“Co-formed fibrous structure” as used herein means that the fibrous structure comprises a mixture of at least two different materials wherein at least one of the materials comprises a filament, such as a polypropylene filament, and at least one other material, different from the first material, comprises a solid additive, such as a fiber and/or a particulate. In one example, a co-formed fibrous structure comprises solid additives, such as fibers, such as wood pulp fibers, and filaments, such as polypropylene filaments.

“Solid additive” as used herein means a fiber and/or a particulate.

“Particulate” as used herein means a granular substance or powder.

“Fiber” and/or “Filament” as used herein means an elongate particulate having an apparent length greatly exceeding its apparent width, i.e. a length to diameter ratio of at least about 10. For purposes of the present invention, a “fiber” is an elongate particulate as described above that exhibits a length of less than 5.08 cm (2 in.) and a “filament” is an elongate particulate as described above that exhibits a length of greater than or equal to 5.08 cm (2 in.).

Fibers are typically considered discontinuous in nature. Non-limiting examples of fibers include wood pulp fibers and synthetic staple fibers such as polyester fibers.

Filaments are typically considered continuous or substantially continuous in nature. Filaments are relatively longer than fibers. Non-limiting examples of filaments include meltblown and/or spunbond filaments. Non-limiting examples of materials that can be spun into filaments include natural polymers, such as starch, starch derivatives, cellulose and cellulose derivatives, hemicellulose, hemicellulose derivatives, and synthetic polymers including, but not limited to polyvinyl alcohol filaments and/or polyvinyl alcohol derivative filaments, and thermoplastic polymer filaments, such as polyesters, nylons, polyhydroxy compounds such as polypropylene filaments, polyethylene filaments, and biodegradable or compostable thermoplastic fibers such as polylactic acid filaments, polyhydroxyalkanoate filaments and polycaprolactone filaments. The filaments may be monocomponent or multicomponent, such as bicomponent filaments.

In one example of the present invention, “fiber” refers to papermaking fibers. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. U.S. Pat. No. 4,300,981 and U.S. Pat. No. 3,994,771 are incorporated herein by reference for the purpose of disclosing layering of hardwood and softwood fibers. Also applicable to the present invention are fibers derived from recycled paper, which may contain any or all of the above categories as well as other non-fibrous materials such as fillers and adhesives used to facilitate the original papermaking

In addition to the various wood pulp fibers, other cellulosic fibers such as cotton linters, rayon, lyocell, trichomes, seed hairs and bagasse can be used in this invention. Other sources of cellulose in the form of fibers or capable of being spun into fibers include grasses and grain sources.

“Sanitary tissue product” as used herein means a soft, low density (i.e. <about 0.15 g/cm³) web useful as a wiping implement for post-urinary and post-bowel movement cleaning (toilet tissue), for otorhinolaryngological discharges (facial tissue), and multi-functional absorbent and cleaning uses (absorbent towels). The sanitary tissue product may be convolutedly wound upon itself about a core or without a core to form a sanitary tissue product roll. Alternatively, the sanitary tissue product may be in the form of discrete sheets. The sanitary tissue product may be a through-air-dried sanitary tissue product, a wet-pressed sanitary tissue product, a belt-creped sanitary tissue product, a fabric-creped sanitary tissue product, a creped sanitary tissue product, or an uncreped sanitary tissue product. In one example, the sanitary tissue product may comprise two or more different plies of a fibrous structure that are made by different processes, for example a through-air-dried fibrous structure ply and a creped fibrous structure ply.

The sanitary tissue products and/or fibrous structures of the present invention may exhibit a basis weight of greater than 15 g/m² to about 120 g/m² and/or from about 15 g/m² to about 110 g/m² and/or from about 20 g/m² to about 100 g/m² and/or from about 30 g/m² to 90 g/m². In addition, the sanitary tissue products and/or fibrous structures of the present invention may exhibit a basis weight between about 40 g/m² to about 120 g/m² and/or from about 50 g/m² to about 110 g/m² and/or from about 55 g/m² to about 105 g/m² and/or from about 60 g/m² to 100 g/m².

The sanitary tissue products of the present invention may exhibit a density (measured at 95 g/in²) of less than about 0.60 g/cm³ and/or less than about 0.30 g/cm³ and/or less than about 0.20 g/cm³ and/or less than about 0.10 g/cm³ and/or less than about 0.07 g/cm³ and/or less than about 0.05 g/cm³ and/or from about 0.01 g/cm³ to about 0.20 g/cm³ and/or from about 0.02 g/cm³ to about 0.10 g/cm³.

“Basis Weight” as used herein is the weight per unit area of a sample reported in lbs/3000 ft² or g/m² and is measured according to the Basis Weight Test Method described herein.

“Caliper” as used herein means the macroscopic thickness of a fibrous structure. Caliper is measured according to the Caliper Test Method described herein.

“Density” as used herein is calculated as the quotient of the Basis Weight expressed in grams per square meter divided by the Caliper expressed in microns.

“Viscosity” as used herein means the viscosity measured using a Brookfield Viscometer #2 spindle at 25° C.

“Bound water” as used herein means water that naturally occurs in the non-water materials that form the surfactant paste composition.

“Free water” as used herein means water within the composition that is added to the non-water materials to form the surfactant paste composition. In other words, free water means any additional water present in the surfactant paste composition that was not bound water.

“Ply” as used herein means an individual, integral fibrous structure.

“Plies” as used herein means two or more individual, integral fibrous structures disposed in a substantially contiguous, face-to-face relationship with one another, forming a multi-ply sanitary tissue product. It is also contemplated that an individual, integral fibrous structure can effectively form a multi-ply sanitary tissue product, for example, by being folded on itself.

### Surfactant Paste Composition

The surfactant paste composition of the present invention is not an aqueous solution of surfactants nor is it a low moisture, high viscosity (greater than 2000 cps) surfactant paste. It is rather a surfactant paste composition comprising a surfactant paste and one or more non-water viscosity reducing agents such that the surfactant paste composition exhibits a viscosity of less than 1000 cps. In one example, the surfactant paste composition is a surfactant paste according to the present invention that has been diluted with a non-water viscosity reducing agent, such as a polyhydroxy compound and/or mono and/or poly alcohols, such that the viscosity of the resulting surfactant paste composition is less than 1000 cps and/or less than 700 cps and/or less than 500 cps.

The surfactant paste composition of the present invention comprises one or more surfactants, for example one or more anionic surfactants, one or more amphoteric surfactants, one or more nonionic surfactants, and/or one or more cationic surfactants and one or more non-water viscosity reducing agents. In one example, the surfactant paste composition comprises an anionic surfactant, for example an alkyl ethoxy sulfate, such as AE_{0.6}S, and an amphoteric surfactant, for example amine oxide. In addition to the anionic surfactant and amphoteric surfactant, the surfactant paste composition comprises one or more non-water viscosity reducing agents. In one non-limiting example, the surfactant paste composition comprises two or more surfactants. Suitable surfactants, discussed below, include anionic surfactants (such as sulfate surfactants, sulfonate surfactants), nonionic surfactants, zwitterionic surfactants, amphotheric surfactants or combinations thereof.

The surfactants present in the surfactant paste composition of the present invention may include sulfate surfactants, for example alkyl ethoxy sulfate surfactants, sulfonate surfactants, for example alkyl benzene sulfonate surfactants, amphoteric surfactants, for example amine oxide surfactants, and nonionic surfactants, for example alcohol alkoxylated surfactants.

In one example, the surfactant paste composition of the present invention exhibits no crystal aggregation as measured according to the Crystallinity Test Method described herein. In another example, the surfactant paste composition of the present invention exhibits a different type and/or different amount of crystallinity compared to aqueous solutions of surfactants as measured according to the Crystallinity Test Method described herein. In still another example, the surfactant paste composition of the present invention exhibits no birefringence as measured according to the Crystallinity Test Method described herein.

In addition to the surfactants and the non-water viscosity reducing agents, the surfactant paste composition of the present invention may include additional amounts of surfactants (additional amounts relative to the surfactant paste from which the surfactant paste composition is made), for example additional amphoteric surfactants, such as amine oxide, and/or additional anionic surfactants, such as alkyl sulfonated surfactants. In one example, the surfactant paste composition comprises greater than 1% and/or greater than 5% and/or greater than 10% and/or less than 30% and/or less than 20% and/or less than 15% by weight of the additional surfactants. In one example, the surfactant paste composition comprises greater than 1% and/or greater than 3% and/or greater than 5% and/or less than 20% and/or less than 15% and/or less than 10% and/or less than 7% by weight of an additional amphoteric surfactant, for example amine oxide. In another example, the surfactant paste composition comprises greater than 5% and/or greater than 10% and/or less than 20% and/or less than 15% by weight of an additional anionic surfactant, such as sodium alkyl ethoxylated fatty alcohol sulfate, for example sodium laureth sulfate (C₁₀-C₁₆).

a. Sulfate Surfactants

Suitable sulfate surfactants for use herein include water-soluble salts of C₈-C₁₈ alkyl or hydroxyalkyl, sulfate and/or ether sulfate. Suitable counterions include alkali metal cation or ammonium or substituted ammonium, or sodium.

The sulfate surfactants may be selected from C₈-C₁₈ primary, branched chain and random alkyl sulfates (AS); C₈-C₁₈ secondary (2,3) alkyl sulfates; C₈-C₁₈ alkyl alkoxy sulfates (AExS) wherein x may be from 1-30 in which the alkoxy group could be selected from ethoxy, propoxy, butoxy or even higher alkoxy groups and mixtures thereof.

Alkyl sulfates and alkyl alkoxy sulfates are commercially available with a variety of chain lengths, ethoxylation and branching degrees, examples are those based on NEODOL® alcohols available from Shell Chemicals, LIAL®-ISALCHEM® and SAFOL® available from Sasol, and/or natural alcohols available from The Procter & Gamble Chemicals Company.

In an embodiment, the cleaning composition may comprise an anionic surfactant having at least 50%, or at least 60% or at least 70% of a sulfate surfactant by weight of the anionic surfactant. In one non-limiting example, the sulfate surfactant is selected from the group consisting of alkyl sulfate, alkyl ethoxy sulfates and mixtures thereof. In a further embodiment, the anionic surfactant has a degree of ethoxylation of from about 0.2 to about 3, or from about 0.3 to about 2, or from about 0.4 to about 1.5, or about 0.4 to about 1. In yet another non-limiting example, the anionic surfactant has a level of branching of from about 5% to about 40%, or from about 10% to 35%, or from about 20% to about 30%.

### b. Sulfonate Surfactants

Suitable sulfonate surfactants for use herein include water-soluble salts of C₈-C₁₈ alkyl or hydroxyalkyl sulfonates; C₁₁-C₁₈ alkyl benzene sulfonates (LAS), modified alkylbenzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548; methyl ester sulfonate (MES); and alpha-olefin sulfonate (AOS). Those also include the paraffin sulfonates may be monosulfonates and/or disulfonates, obtained by sulphonating paraffins of 10 to 20 carbon atoms. The sulfonate surfactants also include the alkyl glyceryl sulfonate surfactants.

### c. Amphoteric Surfactant

Suitable amphoteric surfactants include amine oxides and betaines, including amine oxides.

Suitable amine oxides are alkyl dimethyl amine oxide or alkyl amido propyl dimethyl amine oxide. Amine oxide may have a linear or mid-branched alkyl moiety. Typical linear amine oxides include water-soluble amine oxides containing one C₈₋₁₈ alkyl moiety and two moieties selected from the group consisting of C₁₋₃ alkyl groups and C₁₋₃ hydroxyalkyl groups. In an embodiment, amine oxide is characterized by the formula R1-N(R2)(R3)O wherein R1 is a C₈-₁₈ alkyl and R2 and R3 are selected from the group consisting of methyl, ethyl, propyl, isopropyl, 2-hydroxethyl, 2-hydroxypropyl and 3-hydroxypropyl. The linear amine oxide surfactants in particular may include linear C₁₀-C₁₈ alkyl dimethyl amine oxides and linear C₈-C₁₂ alkoxy ethyl dihydroxy ethyl amine oxides. As used herein “mid-branched” means that the amine oxide has one alkyl moiety having n1 carbon atoms with one alkyl branch on the alkyl moiety having n2 carbon atoms. The alkyl branch is located on the α carbon from the nitrogen on the alkyl moiety. This type of branching for the amine oxide is also known in the art as an internal amine oxide. The total sum of n1 and n2 is from 10 to 24 carbon atoms, or from 12 to 20, and or from 10 to 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that |n1−n2| is less than or equal to 5, or equal to 4, and/or from 0 to 4 carbon atoms in at least 50 wt %, or at least 75 wt % to 100 wt % of the mid-branched amine oxides for use herein.

The amine oxide may further comprise two moieties, independently selected from a C₁₋₃ alkyl, a C₁₋₃ hydroxyalkyl group, or a polyethylene oxide group containing an average of from about 1 to about 3 ethylene oxide groups. The two moieties may be selected from a C₁₋₃ alkyl, or both may be selected as a C₁ alkyl.

### d. Nonionic Surfactants

The surfactant paste composition of the present invention may further comprise a nonionic surfactant, such as an alcohol alkoxylated. Suitable nonionic surfactants include the condensation products of aliphatic alcohols with from 1 to 25 moles of ethylene oxide. The alkyl chain of the aliphatic alcohol can either be straight or branched, primary or secondary, and generally contains from 8 to 22 carbon atoms. One non-limiting example of suitable nonionic surfactants are the condensation products of alcohols having an alkyl group containing from 10 to 18 carbon atoms, or from 10 to 15 carbon atoms with from 2 to 18 moles, or 2 to 15 moles, or 5-12 moles of ethylene oxide per mole of alcohol.

### Anionic to Amphoteric Ratio

The anionic and amphoteric surfactants may be present in the surfactant paste composition and/or the surfactant paste from which the surfactant paste composition is made at a weight ratio of from about 1:1 to about 8.5:1, or at a ratio of at least 1:1 and/or greater than 1:1 and/or greater than 1.5:1 and/or greater than 2:1 to less than 6:1 and/or less than 5:1 and/or less than 4.5:1.

### Non-Water Viscosity Reducing Agents

The surfactant paste composition of the present invention comprises one or more non-water viscosity reducing agents. In one example, the surfactant paste composition comprises a sufficient amount of one or more non-water viscosity reducing agents such that the viscosity of the surfactant paste is reduced by the non-water viscosity reducing agents to produce a viscosity of less than 1000 cps for the resulting surfactant paste composition. In one example, the surfactant paste composition comprises greater than about 10% by weight of one or more non-water viscosity reducing agents. In another example, the surfactant paste composition comprises less than about 70% by weight of one or more non-water viscosity reducing agents. In still another example, the surfactant paste composition comprises from about 14% to about 50% and/or from about 15% to about 40% and/or from about 20% to about 30% by weight of one or more non-water viscosity reducing agents.

Non-limiting examples of suitable non-water viscosity reducing agents include polyhydroxy compounds, such as polyhydric alcohols, polyethylene glycol, mono-alcohols, di-alcohols, and mixtures thereof. In one example, the non-water viscosity reducing agent comprises a polyhydric alcohol, for example polyethylene glycol, such as PEG, for example PEG having a molecular weight of less than 500 g/mol and/or 400 g/mol or less and/or 300 g/mol or less and/or greater than 100 g/mol and/or about 200 g/mol or more. In one example, the non-water viscosity reducing agent is PEG 200. In another example, the surfactant paste composition exhibits a viscosity of less than 1000 and/or less than 500 and/or from about 400 to about 50 cps and/or from about 400 to about 100 cps and/or from about 400 to about 200 cps and/or about 400 cps.

### Surfactant Paste

The surfactant paste of the present invention comprises one or more surfactants described herein that ultimately make up the surfactant paste composition of the present invention, for example one or more anionic surfactants, one or more amphoteric surfactants, one or more nonionic surfactants, and/or one or more cationic surfactants. In one example, the surfactant paste comprises an anionic surfactant, for example an alkyl ethoxy sulfate, such as AE_{0.6}S, and an amphoteric surfactant, for example amine oxide. The surfactants present in the surfactant paste of the present invention may include sulfate surfactants, for example alkyl ethoxy sulfate surfactants, sulfonate surfactants, for example alkyl benzene sulfonate surfactants, amphoteric surfactants, for example amine oxide surfactants, and nonionic surfactants, for example alcohol alkoxylated surfactants.

In one example, the surfactant paste comprises greater than 10% and/or greater than 20% and/or greater than 30% and/or less than 70% and/or less than 60% and/or less than 50% by weight of anionic surfactants, for example sodium alkyl ethoxylated fatty alcohol sulfate. In another example, the surfactant paste comprises from about 30% to about 40% by weight of anionic surfactants, for example sodium alkyl ethoxylated fatty alcohol sulfate.

In another example, the surfactant paste comprises greater than 3% and/or greater than 5% and/or greater than 10% and/or less than 50% and/or less than 40% and/or less than 30% by weight of amphoteric surfactants, for example amine oxide, such as alkyldimethylamine oxide. In another example, the surfactant paste comprises from about 10% to about 20% by weight of amphoteric surfactants, for example amine oxide, such as alkyldimethylamine oxide.

In still another example, the surfactant paste comprises less than 5% and/or less than 3% and/or less than 2% to 0% and/or to about 0% and/or to about 0.05% and/or to about 0.1% and/or to about 1% of nonionic surfactants.

In yet another example, the surfactant paste may be void of cationic surfactants.

In still another example, the surfactant paste comprises greater than 10% and/or greater than 20% and/or greater than 30% and/or less than 70% and/or less than 60% and/or less than 50% by weight of anionic surfactants, for example sodium alkyl ethoxylated fatty alcohol sulfate, and greater than 3% and/or greater than 5% and/or greater than 10% and/or less than 50% and/or less than 40% and/or less than 30% by weight of amphoteric surfactants, for example amine oxide, such as alkyldimethylamine oxide. In another example, the surfactant paste comprises from about 30% to about 40% by weight of anionic surfactants, for example sodium alkyl ethoxylated fatty alcohol sulfate, and from about 10% to about 20% by weight of amphoteric surfactants, for example amine oxide, such as alkyldimethylamine oxide.

One non-limiting example of a surfactant paste suitable for use in the present invention is DUPONOL EP Surfactant, commercially available from DuPont.

### Method for Making a Surfactant Paste Composition

In one embodiment, a method for making a surfactant paste composition of the present invention comprises providing a surfactant paste comprising one or more surfactants. The surfactant paste exhibit a viscosity of 2000 cps or more. In one non-limiting example, the surfactant paste exhibits a viscosity of more than 5000 cps. The method further comprises the step of adding a non-water viscosity reducing agent to the surfactant paste such that the viscosity of the surfactant paste is reduced to less than 1000 cps and/or less than 700 cps and/or less than 500 cps and/or about 400 cps. In one non-limiting example, one or more of the non-water viscosity reducing agents comprises a polyhydroxy compound, such as polyethylene glycol. The polyhydroxy compound may have a molecular weight of 200 or less. Further, in one non-limiting example, the polyhydroxy compound may be provided at a viscosity of about 50 cps. In one example, the polyhydroxy compound forms the continuous phase of the surfactant paste composition.

The method may further include adding one or more additional surfactants to the surfactant paste, before, during, and/or after the addition of the one or more non-water viscosity reducing agents. The additional surfactants, when added, may be much less viscous than the surfactant paste. For example, the additional surfactants may be less than about 10% as viscous as the surfactant paste and/or less than about 1% and/or less than about 0.1% and/or less than about 0.05%. In one non-limiting example, the additional surfactants may exhibit a viscosity of about 10 cps. In another non-limiting example, the additional surfactants may comprise amine oxide. In yet another non-limiting example, the additional surfactants may comprise a zwitterionic surfactant, such as zwitterionic betaine C₁₂.

The method may include a mixing step or a series of mixing steps, wherein the surfactant paste, additional surfactants and non-water viscosity reducing agents are combined. In an embodiment, the surfactant paste, additional surfactants and non-water viscosity reducing agents are combined such that the viscosity of the surfactant paste composition (i.e., the mixture of all 3 components) is less than 1000 cps and/or less than 700 cps and/or less than 500 cps and/or about 400 cps. The surfactant paste, additional surfactants and non-water viscosity reducing agents may be combined in accordance with other formulas suitable to generate a surfactant paste composition according to the present inveniton. In an embodiment, the surfactant paste composition may be obtained by adding (A) 30 to 85% by weight of a surfactant paste, (B) 0 to 25% by weight of additional surfactants and (C) 10 to 70% by weight of a non-water viscosity reducing agent, provided that the sum of A, B and C is 100%.

In a further embodiment, the surfactant paste composition comprises less than about 50%, or about 40% water, or less than about 35% water or less than about 30% water by weight. In another embodiment, the surfactant paste composition comprises greater than about 10% by weight of non-water viscosity reducing agents, for example polyethylene glycol, and/or less than about 70% by weight of non-water viscosity reducing agents, for example polyethylene glycol, and/or from about 14% to about 50% by weight of non-water viscosity reducing agents, for example polyethylene glycol, and/or about 20% by weight of non-water viscosity reducing agents, for example polyethylene glycol.

The surfactant paste composition may include additional components including scents, colorants or dyes, disinfectants, soaps, preservatives, antibacterial components, water, skin benefiting agents, rheology modifiers, and surface treating ingredients.

In one non-limiting example, the surfactant paste composition exhibits a pH of from about 3 to about 10 and/or from about 5 to about 9 and/or from about 6 to about 8.

Without being bound by theory, it believed that the surfactant paste composition formed by the method disclosed herein will form multiple phases. In one example, the non-water viscosity reducing agent, for example a polyhydroxy compound, forms a continuous phase and the surfactants form a micellar and/or lamellar dispersed phase. The micellar and/or lamellar dispersed phase may contain a small amount of crystalline and/or pseudo crystalline structures as well. The internal dispersed phase provides both an immediate source of surfactants once activated by water or other liquids, along with a reservoir of the surfactants. The reservoir of surfactants is due to the more structured and/or large surfactant particles in the dispersed phase that become available as water dilutes the surfactant paste composition.

### Fibrous Structure Comprising Surfactant Paste Composition

The surfactant paste composition of the present invention may be applied to, impregnated in, or otherwise combined with a fibrous structure in any suitable manner known in the art.

The surfactant paste composition may be applied through slot extrusion, printing (e.g., gravure, flexographic), spraying, brushing, transfer rolls or other suitable methods for applying a composition to a fibrous structure, and/or combinations thereof.

Importantly, the surfactant paste composition made in accordance with the present disclosure provides a concentrated yet sufficiently low viscosity composition highly suitable for application to a fibrous structure. A paste, as defined herein as having a viscosity of more than 2000cps, would be very difficult to apply to a fibrous structure given its high viscosity and/or resistance to flow. Such high viscosity would prevent easy absorption and coating of a fibrous structure. Moreover, it would cause plugging up of pumps and supply lines. The surfactant paste composition of the present invention maintains low viscosity at room temperature (e.g., approximately 25° C.) and low shear. While one may reduce the viscosity of a paste through increased temperature and/or high shear, the viscosity would still not be reduced to less than 1000 cps and/or less than 700 cps and/or less than 500 cps and/or about 400 cps to be suitable for the present invention.

In a further embodiment, the fibrous structure of the present invention comprises a surfactant paste composition that contains greater than about 3 gsm and/or greater than about 6 gsm and/or less than 30 gsm and/or less than 20 gsm and/or less than 10 gsm of one or more surfactants. In another embodiment, the surfactant paste composition comprises about 4 gsm of one or more surfactants. Further, the surfactant paste composition may comprise two or more surfactants.

In addition, the surfactant paste composition of the present invention does not require drying once added to the fibrous structure due to avoidance of adding free water to the surfactant paste and thus low water content, especially low free water (not bound) content of the surfactant paste composition. In other words, the surfactant paste composition may be added to the fibrous structure and the fibrous structure may be dry-to-the-touch instantly and microbial growth issues may be avoided. If the fibrous structure is not instantly dry-to-the-touch, the treated fibrous structure will return to an equilibrium moisture faster than would a substantially liquid surfactant for a given surfactant add-on level and set of environmental conditions. With substantially liquid surfactant compositions, drying with heaters or other apparatuses and/or for several hours is necessary to remove the excess water in the composition. With these other compositions, the water level needs to be high enough to make the composition sufficiently thin to coat.

Further, that the addition of a non-water viscosity reducing agent, such as a polyhydroxy compound, for example polyethylene glycol, to a surfactant paste in accordance with the present disclosure causes the surfactant paste composition to circumvent a hexagonal or hexagonal-like phase that would otherwise occur when surfactant solutions are mixed with other chemicals (e.g., to reduce their viscosity), when small amounts of water are added to highly viscous surfactants, and/or when surfactant solutions are dried (e.g., to make a concentrated surfactant paste). The hexagonal or hexagonal-like phase, viscous isotropic phase and/or neat phase that some surfactants undergo is very viscous and/or highly structured, making it hard for the surfactants to breakdown and solubilize in water. This likely contributes to a slowing of dissolution and suds generation. Without being bound by theory, it is believed that avoidance of the hexagonal phase or a hexagonal-like phase increases the solubility of the surfactant, facilitating the mixing of the surfactant with water and thereby making the manufacture of the surfactant paste composition easier. Avoidance of the hexagonal phase also allows more immediate dispersion of the surfactant paste composition upon initial contact with water during end use of the dry-to-the-touch fibrous structure. This faster surfactant dispersion results in more initial suds and fewer suds during subsequent rinses of the fibrous structure. The finite amount of surfactant paste composition in the dry-to-the-touch fibrous structure is consumed faster during the first cleaning step to create more suds and cleaning power when the consumer needs it. After subsequent wetting steps, the suds are decreased to promote easier rinsing.

Moreover, a surfactant paste as described herein yields a greater surfactant content than known liquid surfactant compositions, for example aqueous solutions of surfactants. Thus, one can use less surfactant paste composition of the present invention and achieve the same or better cleaning performance and suds performance than known products.

In one embodiment, the fibrous structure of the present invention exhibits a HFS of greater than about 23.3 g/g according to the HFS Test Method described herein. In another embodiment, the fibrous structure of the present invention exhibits a VFS of greater than about 9.1 g/g according to the VFS Test Method described herein. In yet another embodiment, the fibrous structure of the present invention exhibits a CRT value of greater than about 18.2 g/g as determined by the Capacity Rate Test Method described herein. In a further embodiment, the fibrous structure of the present invention is a two-ply structure that exhibits a HFS of greater than about 23.3 g/g, a VFS of greater than about 9.1 g/g, and/or a CRT value of greater than about 18.2 g/g or combinations thereof. In yet another embodiment, the fibrous structure of the present invention has more than two plies.

In another embodiment, the fibrous structure comprises a plurality of pulp fibers.

In yet another embodiment, the fibrous structure comprises a plurality of filaments. In one non-limiting example, the plurality of filaments comprises polypropylene filaments. The plurality of filaments may comprise greater than about 20%, or greater than about 30%, or greater than about 40%, or greater than about 50%, or greater than about 60% or up to about 100% by weight of polypropylene filaments. In one non-limiting example, the fibrous structure is co-formed. In another example, one or more of the filaments may comprise a coloring agent such as a dye, for example a blue dye.

The fibrous structure can include additional components including scents, colorants or dyes, skin benefiting agents and surface treating ingredients. The fibrous structure may also comprise indicators of performance and/or ingredients, such as colors, blossoming scents, logos or textures. The fibrous structure may be embossed and/or creped. The fibrous structure may be a sanitary tissue product, such as a paper towel product. In one embodiment, the fibrous structure is multi-ply. In another example, the fibrous structure may be a multi-ply fibrous structure that comprises a ply bond glue or adhesive, which may contain a coloring agent, such as a blue dye. The ply bond glue or adhesive may be present at the embossments, when present, in the multi-ply fibrous structure.

### Suds Profile

The fibrous structure of the present invention comprising a surfactant paste composition in accordance with the present invention may exhibit a Suds Retention Value of less than about 55% and/or less than about 50% and/or less than about 45% and/or greater than 0% and/or greater than 5% as measured according the Suds Volume Test Method described herein.

In another embodiment, the fibrous structure of the present invention comprising a surfactant paste composition exhibits an Initial Suds Volume of greater than about 40 mL and/or greater than 45 mL and/or greater than 50 mL and/or greater than 60 mL and/or less than 200 mL and/or less than 150 mL and/or less than 100 mL as measured according to the Suds Volume Test Method described herein. The fibrous structure of the present invention may also exhibit a Suds Retention Value of less than about 55% and/or less than about 50% and/or less than about 45% and/or greater than 0% and/or greater than 5% as measured according the Suds Volume Test Method described herein. Further, the cleaning composition may comprise two or more surfactants. The surfactants may be present at any amount suitable to yield an Initial Suds Volume of greater than about 40 mL measured according to the Suds Volume Test Method described herein.

In another embodiment, the fibrous structure may exhibit an Initial Suds Volume of greater than 60 mL or greater than 70 mL or greater than 80 mL or greater than 90 mL measured according to the Suds Volume Test Method described herein. In yet another embodiment, the fibrous structure may exhibit a Suds Retention Value of less than about 70% and/or less than about 60% and/or less than about 30% and/or less than about 20% as measured according to the Suds Volume Test Method described herein.

In one non-limiting example, the fibrous structure comprises a surfactant paste composition that comprises an anionic surfactant, a nonionic surfactant, an amphoteric surfactant, and/or a zwitterionic surfactant or combinations thereof. In another embodiment, the fibrous structure comprises a surfactant paste composition that comprises greater than about 27%, or greater than about 28%, or greater than about 30%, or greater than about 50% and/or to about 90% and/or to about 80% and/or to about 70% and/or to about 60% by weight of one or more surfactants.

In another embodiment, the surfactant paste composition comprises a surfactant paste, additional surfactants (a fluid surfactant solution) and a non-water viscosity reducing agent (i.e., a polyhydroxy compound). The surfactant paste composition may be made in accordance with the disclosure above. In yet another non-limiting example, the fibrous structure comprises a surfactant paste composition that is greater than about 10% by weight of a non-water viscosity reducing agent, for example a polyhydroxy compound, such as polyethylene glycol, and/or less than about 70% by weight of a non-water viscosity reducing agent, for example a polyhdyroxy compound, such as polyethylene glycol, and/or from about 14% to about 50% by weight of a non-water viscosity reducing agent, for example a polyhdyroxy compound, such as polyethylene glycol, and/or about 20% by weight of a non-water viscosity reducing agent, for example a polyhdyroxy compound, such as polyethylene glycol. Without being bound by theory, it is believed that addition of the polyhydroxy compound enhances the stability and longevity of suds. The polyhydroxy compound causes less interference with the structure of the suds than water alone would. When flowing through suds, water causes the polar ends of a suds' micellar structure to break away from one another and thereby destroys the suds. On the other hand, the polyhydroxy compound may at least partially shield the polar ends from reaction with water. Indeed, it is believed that the larger molecules of the polyhydroxy compound may actually hold some of the polar ends in place, creating a stronger structure.

The fibrous structure may comprise about 15% or less and/or about 12.5% or less and/or about 10% or less and/or about 7.5% of less and/or about 5% or less by weight of the surfactant paste composition.

### Cleaning and Residue Removal

In one example, the fibrous structure of the present invention comprising a surfactant paste composition provides superior cleaning performance than other known fibrous structure products having a cleaning and/or surfactant solution. In addition, it is believed that the fibrous structure of the present invention comprising a surfactant paste composition will leave less residue (from surfactants and/or grease and/or dirt) on surfaces and dishes than other known products in the same field.

Further, even if the surfactant paste composition made in accordance with this disclosure left some amount of residue on a surface, such residue would be less visible. The reduction of visibility may be due to the addition of a polyhydroxy compound. Generally, a residue will dry into a film once on a surface and/or dish. Polyhydroxy compounds are much less volatile than water and do not easily evaporate from a residue as it is drying on a surface. Moreover, even with low volatility, the polyhydroxy compounds may remain mobile in the residue film. The presence and mobility of the polyhydroxy compound creates a thinner, more discrete, less continuous and less crystalline residue film than that left by known products. It is believed that the avoidance of a hexagonal phase (as explained above) reduces the affinity for reaggregation of the surfactant once on a surface or dish. In other words, the surfactant remains dispersed in the polyhydroxy compound. This dispersion prevents noticeable recrystallation, re-aggregation to a limit and buildup of the surfactant or other residue on the surface or dish. In addition, the mobility of the polyhydroxy compound causes the entire film to spread further, and therefore become thinner, than residue films of other products.

Moreover, the presence of polyhydroxy compounds in the residue film may also increase the water solubility of any the residue on the surface, making it easier to remove during subsequent cleaning steps.

In one example, the fibrous structures comprising the surfactant paste composition of the present invention exhibits a higher Gloss Value as measured according to the Gloss Test Method than known fibrous structures comprising one or more surfactants, for example an aqueous solution of one or more surfactants as shown in Table 1 below.

TABLE 1

| | | | | | Delta Gloss |
|---|---|---|---|---|---|
| | | | Incidence | Gloss | Value vs. |
| Substrate | 1% Solution | Soil | Angle (°) | Value | Control |
| 2014 Bounty ® | N/A | Lard | 60 | >120 | N/A |
| Basic (Control- | | | | | |
| No Surfactant) | | | | | |
| 2014 Bounty ® | Surfactant | Lard | 60 | >120 | <3 |
| Basic | Paste- | | | | |
| | Invention | | | | |
| 2014 Bounty ® | Dawn Ultra | Lard | 60 | <90 | >35 |
| Basic | Liquid | | | | |
| | Dishwashing | | | | |
| 2014 Bounty ® | Lumorol K5240 | Lard | 60 | <85 | >37 |
| Basic | | | | | |

In one example, the fibrous structures of the present invention comprising a surfactant paste composition exhibit a Gloss Value of greater than 90° and/or greater than 100° and/or greater than 110° and/or greater than 120° as measured according to the Gloss Test Method.

### Method for Making a Fibrous Structure

A fibrous structure suitable for use in the present invention may be made by any suitable process known in the art.

In one example, a process for making fibrous structure, such as a wet-laid fibrous structure, comprising a surfactant paste of the present invention comprises the steps of:
a. providing a fiber slurry;
b. depositing the fiber slurry onto a foraminous wire to form an embryonic web;
c. drying the embryonic web, for example at least partially on a patterned belt, to produce a fibrous structure; and
d. contacting the fibrous structure with a surfactant paste of the present invention to produce a fibrous structure, for example a dry fibrous structure) comprising a surfactant paste of the present invention.

The fiber slurries and/or fibrous structures may comprise permanent and/or temporary wet strength agents such as Kymene® (permanent wet strength) and Hercobond® (temporary wet strength) both available from Ashland Inc. and/or Parez® (wet strength chemistries) available from Kemira Chemicals, Inc.

The fiber slurries and/or fibrous structures may comprise dry strength agents such as carboxymethylcellulose, starch, polyvinylamides, polyethyleneimines, melamine/formaldehyde, epoxide, and mixtures thereof.

In still yet another example, a process for making a fibrous structure, such as an air-laid fibrous structure, comprises the steps of:
a. providing pulp fibers;
b. producing an air-laid fibrous structure from the pulp fibers; and
c. optionally applying a binder, for example a latex binder, to a surface of the air-laid fibrous structure; and
d. contacting the air-laid fibrous structure with a surfactant paste of the present invention to produce a fibrous structure comprising a surfactant paste of the present invention.

In one example, the surfactant paste of the present invention may be added to a fibrous structure during papermaking, between the Yankee dryer and the reel, and/or during converting by applying it to one or more surfaces of the fibrous structure. In one example, a single-ply paper towel comprises the surfactant paste of the present invention on one surface of the paper towel. In another example, a single-ply paper towel comprises the surfactant paste of the present invention on both surfaces of the paper towel. In still another example, a two-ply paper towel comprises the surfactant paste of the present invention on one or both exterior surfaces of the two-ply paper towel. In still another example, a two-ply paper towel comprises the surfactant paste of the present invention on one or more interior surfaces of the two-ply paper towel. In yet another example, a two-ply paper towel comprises the surfactant paste of the present invention on one or more exterior surfaces and one or more interior surfaces of the two-ply paper towel. One of ordinary skill would understand that one or more exterior surfaces and one or more interior surfaces of a three or more ply paper towel could comprise the surfactant paste of the present invention.

In another example, a fibrous structure comprising a surfactant paste of the present invention may be made by printing a surfactant paste onto a surface of a fibrous structure, for example in a converting operation. The printing operation may occur by any suitable printing equipment, for example by way of a gravure roll and/or by a permeable fluid applicator roll.

In still another example, a fibrous structure comprising a surfactant paste of the present invention may be made by extruding a surfactant paste onto a surface of a fibrous structure.

In even another example, a fibrous structure comprising a surfactant paste of the present invention may be made by spraying a surfactant paste onto a surface of a fibrous structure. In yet another example, a fibrous structure comprising a surfactant paste of the present invention may be made by spraying a surfactant paste onto a wet fibrous structure during papermaking after the vacuum dewatering step, but before the pre-dryers and/or after the pre-dryers, but before the Yankee.

In even yet another example, a fibrous structure comprising a surfactant paste of the present invention may be made by depositing a plurality of fibers mixed with a surfactant paste of the present invention in an air-laid and/or coform process.

In still another example, a fibrous structure comprising a surfactant paste of the present invention may be made by adding one or more surfactant pastes of the present invention at acceptable locations within spunbonding, meltblowing, dry spinning, carding, and/or hydro entangling processes.

The surfactant paste of the present invention may be applied to and/or included in a fibrous structure in a pattern, such as a non-random, repeating pattern.

Another non-limiting example of a method for making a fibrous structure according to the present invention comprises the step of mixing a plurality of solid additives with a plurality of filaments to form a fibrous structure, a coformed fibrous structure, an example of which is described in U.S. Pat. No. 7,972,986 incorporated herein by reference. In one example, the solid additives are wood pulp fibers, such as SSK fibers and/or Eucalytpus fibers, and the filaments are polypropylene filaments. The solid additives may be combined with the filaments, such as by being delivered to a stream of filaments from a hammermill via a solid additive spreader to form a mixture of filaments and solid additives. The filaments may be created by meltblowing from a meltblow die. The mixture of solid additives and filaments are collected on a collection device, such as a belt to form a fibrous structure. The collection device may be a patterned and/or molded belt that results in the fibrous structure exhibiting a surface pattern, such as a non-random, repeating pattern of microregions. The molded belt may have a three-dimensional pattern on it that gets imparted to the fibrous structure during the process. The pattern may comprise a continuous or semi-continuous network of the polymer resin within which one or more discrete conduits are arranged.

In one example of the present invention, the fibrous structures are made using a die comprising at least one filament-forming hole, and/or 2 or more and/or 3 or more rows of filament-forming holes from which filaments are spun. At least one row of holes contains 2 or more and/or 3 or more and/or 10 or more filament-forming holes. In addition to the filament-forming holes, the die comprises fluid-releasing holes, such as gas-releasing holes, in one example air-releasing holes, that provide attenuation to the filaments formed from the filament-forming holes. One or more fluid-releasing holes may be associated with a filament-forming hole such that the fluid exiting the fluid-releasing hole is parallel or substantially parallel (rather than angled like a knife-edge die) to an exterior surface of a filament exiting the filament-forming hole. In one example, the fluid exiting the fluid-releasing hole contacts the exterior surface of a filament formed from a filament-forming hole at an angle of less than 30° and/or less than 20° and/or less than 10° and/or less than 5° and/or about 0° . One or more fluid releasing holes may be arranged around a filament-forming hole. In one example, one or more fluid-releasing holes are associated with a single filament-forming hole such that the fluid exiting the one or more fluid releasing holes contacts the exterior surface of a single filament formed from the single filament-forming hole. In one example, the fluid-releasing hole permits a fluid, such as a gas, for example air, to contact the exterior surface of a filament formed from a filament-forming hole rather than contacting an inner surface of a filament, such as what happens when a hollow filament is formed.

In one example, the die comprises a filament-forming hole positioned within a fluid-releasing hole. The fluid-releasing hole may be concentrically or substantially concentrically positioned around a filament-forming hole.

After the fibrous structure has been formed on the collection device, such as a patterned belt or a woven fabric for example a through-air-drying fabric, the fibrous structure may be calendered, for example, while the fibrous structure is still on the collection device. In addition, the fibrous structure may be subjected to post-processing operations such as embossing, thermal bonding, tuft-generating operations, moisture-imparting operations, and surface treating operations to form a finished fibrous structure. One example of a surface treating operation that the fibrous structure may be subjected to is the surface application of a surfactant paste according to the present invention. The surfactant paste may be applied to one or more surfaces of the fibrous structure in a pattern, especially a non-random, repeating pattern of microregions, or in a manner that covers or substantially covers the entire surface(s) of the fibrous structure.

In one example, the fibrous structure and/or the finished fibrous structure may be combined with one or more other fibrous structures. For example, another fibrous structure, such as a filament-containing fibrous structure, such as a polypropylene filament fibrous structure may be associated with a surface of the fibrous structure and/or the finished fibrous structure. The polypropylene filament fibrous structure may be formed by meltblowing polypropylene filaments (filaments that comprise a second polymer that may be the same or different from the polymer of the filaments in the fibrous structure) onto a surface of the fibrous structure and/or finished fibrous structure. In another example, the polypropylene filament fibrous structure may be formed by meltblowing filaments comprising a second polymer that may be the same or different from the polymer of the filaments in the fibrous structure onto a collection device to form the polypropylene filament fibrous structure. The polypropylene filament fibrous structure may then be combined with the fibrous structure or the finished fibrous structure to make a two-ply fibrous structure—three-ply if the fibrous structure or the finished fibrous structure is positioned between two plies of the polypropylene filament fibrous structure. The polypropylene filament fibrous structure may be thermally bonded to the fibrous structure or the finished fibrous structure via a thermal bonding operation.

In yet another example, the fibrous structure and/or finished fibrous structure may be combined with a filament-containing fibrous structure such that the filament-containing fibrous structure, such as a polysaccharide filament fibrous structure, such as a starch filament fibrous structure, is positioned between two fibrous structures or two finished fibrous structures.

### Non-limiting Examples

### Example 1

### A Dry-to-the-Touch Paper Towel Comprising a Surfactant Paste Composition

Examples of dry fibrous structures; namely, paper towels, are produced utilizing a cellulosic pulp fiber furnish consisting of about 55% refined softwood furnish consisting of about 44% Northern Bleached Softwood Kraft (Bowater), 44% Northern Bleached Softwood Kraft (Celgar) and 12% Southern Bleached Softwood Kraft (Alabama River Softwood, Weyerhaeuser); about 30% of unrefined hardwood Eucalyptus Bleached Kraft consisting of about 80% (Fibria) and 20% NBHK (Aspen) (Peace River); and about 15% of an unrefined furnish consisting of a blend of about 27% Northern Bleached Softwood Kraft (Bowater), 27% Northern Bleached Softwood Kraft (Celgar), 42% Eucalyptus Bleached Kraft (Fibria) and 7% Southern Bleached Kraft (Alabama River Softwood, Weyerhaeuser). The 55% refined softwood is refined as needed to maintain target wet burst at the reel. Any furnish preparation and refining methodology common to the papermaking industry can be utilized.

A 3% active solution Kymene 5221 is added to the refined softwood line prior to an in-line static mixer and 1% active solution of Wickit 1285, an ethoxylated fatty alcohol available from Ashland Inc. is added to the unrefined Eucalyptus Bleached Kraft (Fibria) hardwood furnish. The addition levels are 21 and 1 lbs active/ton of paper, respectively.

The refined softwood and unrefined hardwood and unrefined NBSK/SSK/Eucalyptus bleached kraft/NDHK thick stocks are then blended into a single thick stock line followed by addition of 1% active carboxymethylcellulose (CMC- Finnfix) solution at 7 lbs active/ton of paper towel, and optionally, a softening agent may be added.

The thick stock is then diluted with white water at the inlet of a fan pump to a consistency of about 0.15% based on total weight of softwood, hardwood and simulated broke fiber. The diluted fiber slurry is directed to a non layered configuration headbox such that the wet web formed onto a Fourdrinier wire (foraminous wire). Optionally, a fines retention/drainage aid may be added to the outlet of the fan pump.

Dewatering occurs through the Fourdrinier wire and is assisted by deflector and vacuum boxes. The Fourdrinier wire is of a 5-shed, satin weave configuration having 87 machine-direction and 76 cross-direction monofilaments per inch, respectively. The speed of the Fourdrinier wire is about 750 fpm (feet per minute).

The embryonic wet web is transferred from the Fourdrinier wire at a fiber consistency of about 24% at the point of transfer, to a belt, such as a patterned belt through-air-drying resin carrying fabric. In the present case, the speed of the patterned through-air-drying fabric is approximately the same as the speed of the Fourdrinier wire. In another case, the embryonic wet web may be transferred to a patterned belt and/or fabric that is traveling slower, for example about 20% slower than the speed of the Fourdrinier wire (for example a wet molding process).

Further de-watering is accomplished by vacuum assisted drainage until the web has a fiber consistency of about 30%.

While remaining in contact with the patterned belt, the web is pre-dried by air blow-through pre-dryers to a fiber consistency of about 65% by weight.

After the pre-dryers, the semi-dry web is transferred to a Yankee dryer and adhered to the surface of the Yankee dryer with a sprayed creping adhesive. The creping adhesive is an aqueous dispersion with the actives consisting of about 75% polyvinyl alcohol, and about 25% CREPETROL® R6390. Optionally a crepe aid consisting of CREPETROL® A3025 may be applied. CREPETROL® R6390 and CREPETROL® A3025 are commercially available from Ashland Inc. (formerly Hercules Inc.). The creping adhesive diluted to about 0.15% adhesive solids and delivered to the Yankee surface at a rate of about 2# adhesive solids based on the dry weight of the web. The fiber consistency is increased to about 97% before the web is dry creped from the Yankee with a doctor blade.

In the present case, the doctor blade has a bevel angle of about 45° and is positioned with respect to the Yankee dryer to provide an impact angle of about 101° and the reel is run at a speed that is about 15% faster than the speed of the Yankee. In another case, the doctor blade may have a bevel angle of about 25° and be positioned with respect to the Yankee dryer to provide an impact angle of about 81° and the reel is run at a speed that is about 10% slower than the speed of the Yankee. The Yankee dryer is operated at a temperature of about 177 ° C. and a speed of about 800 fpm. The fibrous structure is wound in a roll using a surface driven reel drum having a surface speed of about 656 feet per minute.

The fibrous structure may be subsequently converted into a two-ply paper towel product having a basis weight of about 45 to 54 g/m². During the converting operation, a surfactant paste composition comprising a surfactant paste is applied to the fibrous structure to produce a dry fibrous structure (dry paper towel) comprising the surfactant paste composition by any suitable means, for example by slot extruding on the surfactant paste composition to one or more surfaces of the fibrous structure.

### Example 2

### A Dry-to-the Touch Paper Towel Comprising Greater than 20% Synthetic Filaments and Comprising a Surfactant Paste Composition

A 21.%:27.5%47.5%:4% blend of Lyondell-Basell PH835 polypropylene:Lyondell-Basell Metocene MF650W polypropylene:Lyondell-Basell Metocene MF650X:Ampacet 412951 opacifier is dry blended, to form a melt blend. The melt blend is heated to 475° F. through a melt extruder. A 15.5 inch wide Biax 12 row spinnerette with 192 nozzles per cross-direction inch, commercially available from Biax Fiberfilm Corporation, is utilized. 40 nozzles per cross-direction inch of the 192 nozzles have a 0.018 inch inside diameter while the remaining nozzles are solid, i.e. there is no opening in the nozzle. Approximately 0.19 grams per hole per minute (ghm) of the melt blend is extruded from the open nozzles to form meltblown filaments from the melt blend. Approximately 375 SCFM of compressed air, equivalent to a jet-to-melt mass ratio of 22, is heated such that the air exhibits a temperature of about 395° F. at the spinnerette. Approximately 475 g/minute of Golden Isle (from Georgia Pacific) 4825 semi-treated SSK pulp is defibrillated through a hammermill to form SSK wood pulp fibers (solid additive). Air at a temperature of about 85 to 90° F. and about 85% relative humidity (RH) is drawn into the hammermill. Approximately 1200 SCFM of air carries the pulp fibers to a solid additive spreader. The solid additive spreader turns the pulp fibers and distributes the pulp fibers in the cross-direction such that the pulp fibers are injected into the meltblown filaments in a perpendicular fashion (with respect to the flow of the meltblown filaments) through a 4 inch x 15 inch cross-direction (CD) slot. A forming box surrounds the area where the meltblown filaments and pulp fibers are commingled. This forming box is designed to reduce the amount of air allowed to enter or escape from this commingling area; however, there is an additional 4 inch x 15 inch spreader opposite the solid additive spreader designed to add cooling air. Approximately 1000 SCFM of air at approximately 80° F. is added through this additional spreader. A forming vacuum pulls air through a collection device, such as a patterned belt, thus collecting the commingled meltblown filaments and pulp fibers to form a fibrous structure comprising a pattern of non-random, repeating microregions. The fibrous structure formed by this process comprises about 75% by dry fibrous structure weight of pulp and about 25% by dry fibrous structure weight of meltblown filaments.

A meltblown layer of the meltblown filaments, such as a scrim, is added to both sides of the above formed fibrous structure. This addition of the meltblown layer can help reduce the lint created from the fibrous structure during use by consumers and is preferably performed prior to any thermal bonding operation of the fibrous structure. The two scrim layers can be the same or different than the meltblown filaments in the center formed fibrous structure. To make the meltblown filaments for the exterior layers, A 15.5 inch wide Biax 12 row spinnerette with 192 nozzles per cross-direction inch, commercially available from Biax Fiberfilm Corporation, is utilized. 64 nozzles per cross-direction inch of the 192 nozzles have a 0.018 inch inside diameter while the remaining nozzles are solid, i.e. there is no opening in the nozzle. Approximately 0.21 grams per hole per minute (ghm) of the melt blend is extruded from the open nozzles to form meltblown filaments from the melt blend. Approximately 420 SCFM of compressed air, equivalent to a jet-to-melt mass ratio of 22, is heated such that the air exhibits a temperature of about 395° F. at the spinnerette. A forming vacuum pulls air through a collection device, such as a non-patterned forming belt or through-air-drying fabric, thus collecting the meltblown filaments to form a fibrous structure on top of the above formed fibrous structure.

An additional meltblown layer, such as a scrubbing scrim layer, is added to one side of the above layered fibrous structure. The basis weight and filament diameter of such meltblown layer is important in controlling its surface roughness. The meltblown filaments for this layer can be the same or different than the meltblown filaments used in other layers. To make the meltblown filaments for this scrubbing scrim layer, A 15.5 inch wide Biax 12 row spinnerette with 192 nozzles per cross-direction inch, commercially available from Biax Fiberfilm Corporation, is utilized. 64 nozzles per cross-direction inch of the 192 nozzles have a 0.018 inch inside diameter while the remaining nozzles are solid, i.e. there is no opening in the nozzle. Approximately 0.21 grams per hole per minute (ghm) of the melt blend is extruded from the open nozzles to form meltblown filaments from the melt blend. Approximately 88 SCFM of compressed air, equivalent to a jet-to-melt mass ratio of 4.6, is heated such that the air exhibits a temperature of about 395° F. at the spinnerette. A forming vacuum pulls air through a collection device, such as a non-patterned forming belt or through-air-drying fabric, thus collecting the meltblown filaments to form a fibrous structure on top of the above formed fibrous structure.

The fibrous structure may be subsequently converted into a two-ply paper towel product having a basis weight of about 45 to 54 g/m². During the converting operation, a surfactant paste composition comprising a surfactant paste is applied to the fibrous structure to produce a dry fibrous structure (dry paper towel) comprising the surfactant paste composition by any suitable means, for example by slot extruding on the surfactant paste composition to one or more surfaces of the fibrous structure.

### Test Methods

### Suds Volume Test Method

a) Sample Conditioning and Preparation

Samples are conditioned according to Tappi Method #T4020M-88. Paper samples are conditioned for at least 2 hours at a relative humidity of 48 to 52% and within a temperature range of 22° to 24° C. Sample preparation and all aspects of testing using the following methods are confined to a constant temperature and humidity room.

Stack three sheets of a test substrate together. Cut a 10 cm×10 cm square from the test substrate stack, being sure to cut through each sheet. Separate the 10 cm×10 cm squares into three samples.

b) Equipment Preparation

Obtain a 60 ml slip-tip syringe catalog #309654 from Becton, Dickinson and Company (1 Becton Drive, Franklin Lakes, N.J. 07417).

Obtain a 20 ml scintillation vial with screw cap model VW74504-20 from Kimble (1022 Spruce Street, PO Box 1502, Vineland, N.J. 08362). Prepare a perforated septum by first removing any liner inside the cap and then placing four, equally spaced 2.2 mm diameter holes in the top of the screw cap.

Obtain a 600 ml glass beaker model 89000-208 from VWR (100 Matsonford Road Radnor, Pa. 19087).

Obtain a 100 ml graduated glass cylinder with 1.0 ml graduations model 3025-100 from Pyrex (836 North Street, Tewksbury Mass. 01876).

Clean the syringe, perforated septum, beaker, and graduated cylinder and rinse in distilled water.

c) Suds Test

Fill the beaker with 500 ml of 22° to 24° C. distilled water. Place the perforated septum void side down in the bottom of the 60 ml syringe. Roll a 10 cm×10 cm product sample into a cylindrical form and place into the syringe on top of the septum. Place the piston in the syringe.

Squeeze #1:

Push the syringe piston to the 20 ml mark. Submerge the tip end of the syringe in the beaker until the 25 ml mark on the syringe is level with the water's surface. Smoothly pull the syringe piston to the 60 ml mark to fill the interior of the syringe with 40 ml of distilled water. Observe the product sample and confirm that it is saturated with water and partially open in the water. Do not shake the syringe to open the sample. If the product sample is still compressed or not fully wet, dispose of the sample and start a new sample.

Place the syringe above the empty 100 ml graduated cylinder. Use a smooth motion to push the piston down to the 10 ml mark in one second. Immediately mark the highest level of suds that span the full cross sectional area of the graduated cylinder to the nearest milliliter. This is top suds level for squeeze 1. Do not include suds that cling to the cylinder's sides above the suds meniscus in determining top suds level. Immediately after marking the top suds level, locate and mark the level of the suds-liquid boundary. This is liquid level for squeeze 1. The suds-liquid boundary is identified by the visible line that separates dense suds foam from slightly cloudy, not necessarily clear, liquid. After marking the top suds level and liquid level, record the top suds level and the liquid level to the nearest milliliter. If top suds level exceeds the 100 ml line on the cylinder, determine the top suds level by measuring the distance above the 100 ml line and equating that distance to the graduation spacing below the 100 ml line and adding 100 ml to it. Suds volume is the difference between top suds level and liquid level, reported in milliliters. Empty the water and suds from the graduated cylinder. Rinse the graduated cylinder with distilled water.

Squeeze #2:

Maintain the syringe piston at the 10 ml mark. Submerge the tip end of the syringe in the beaker until the 25 ml mark on the syringe is level with the water's surface. Smoothly pull the syringe piston to the 50 ml mark to fill the interior of the syringe with 40 ml of distilled water. This time the paper may or may not remain compressed. Ensure that no air bubbles are trapped within the syringe, although a small amount of foam may be associated with the paper sample. Place the syringe above the empty 100 ml graduated cylinder. Use a smooth motion to push the piston down to the 10 ml mark in one second. Immediately mark the highest level of suds that span the full cross sectional area of the graduated cylinder to the nearest milliliter. This is top suds level for squeeze 2. Do not include suds that cling to the cylinder's sides above the suds meniscus in determining top suds level. Immediately after marking the top suds level, locate and mark the level of the suds-liquid boundary. This is liquid level for squeeze 2. The suds-liquid boundary is identified by the visible line that separates dense suds foam from slightly cloudy, not necessarily clear, liquid. After marking the top suds level and liquid level, record the top suds level and the liquid level to the nearest milliliter. If top suds level exceeds the 100 ml line on the cylinder, determine the top suds level by measuring the distance above the 100 ml line and equating that distance to the graduation spacing below the 100 ml line and adding 100 ml to it. Suds volume is the difference between top suds level and liquid level, reported in milliliters. Empty the water and suds from the graduated cylinder. Rinse the graduated cylinder with distilled water.

Squeeze #3:

Repeat the procedure used for Squeeze #2 using the remaining distilled water in the beaker. Record the top suds level and liquid level for squeeze 3. Then open the syringe and discard the product sample.

Clean the syringe, perforated septum, beaker, and graduated cylinder and rinse in distilled water.

Repeat the test twice more with the remaining two 10 cm×10 cm product samples.

d) Calculations

Initial Suds Volume is the average of squeeze #1 suds volumes for the three samples of the test substrate.

Second Suds Volume is the average of squeeze #2 suds volumes for the three samples of the test substrate.

Third Suds Volume is the average of squeeze #3 suds volumes for the three samples of the test substrate.

Total Suds is the sum of Initial Suds Volume, Second Suds Volume, and Third Suds Volume for a test substrate

Suds Retention Value is the Third Suds Volume divided by the Initial Suds Volume for a given test substrate.

Suds Depreciation Value is the difference of Initial Suds Volume and the Third Suds Volume divided by the Initial Suds Volume (i.e., (Initial Suds Volume—Third Suds Volume)/Initial Suds Volume)).

Initial Suds Volume, Second Suds Volume and Third Suds Volume are reported in milliters. Suds Retention Value and Suds Depreciation Value are reported in percentages.

### Basis Weight Test Method

Basis weight of a fibrous structure is measured on stacks of twelve usable units using a top loading analytical balance with a resolution of ±0.001 g. The balance is protected from air drafts and other disturbances using a draft shield. A precision cutting die, measuring 3.500 in±0.0035 in by 3.500 in±0.0035 in is used to prepare all samples.

With a precision cutting die, cut the samples into squares. Combine the cut squares to form a stack twelve samples thick. Measure the mass of the sample stack and record the result to the nearest 0.001 g. The stack should not contact the draft shield during measurement of its weight.

The Basis Weight is calculated in lbs/3000 ft² or g/m² as follows:

Basis Weight=(Mass of stack)/[(Area of 1 square in stack)×(No. of squares in stack)]

For example,

Basis Weight (lbs/3000 ft²)=[[Mass of stack (g)/453.6 (g/lbs)]/[12.25 (in²)/144 (in²/ft²)×12]] ×3000

or,

Basis Weight (g/m²)=Mass of stack (g)/[79.032 (cm²)/10,000 (cm²/m²)×12]

Report result to the nearest 0.1 lbs/3000 ft² or 0.1 g/m². Sample dimensions can be changed or varied using a similar precision cutter as mentioned above, so as at least 100 square inches of sample area in stack.

### Caliper Test Method

Caliper of a fibrous structure and/or sanitary tissue product is measured using a Progage Thickness Tester Model II (Thwing-Albert Instrument Company, West Berlin, N.J.) with a pressure foot diameter of 2.00 inches (area of 3.14 in^{t}) at a pressure of 95 g/in². Four (4) samples are prepared by cutting of a usable unit such that each cut sample is at least 2.5 inches per side, avoiding creases, folds, and obvious defects. Create two stacks, with two samples in each, directionally aligned (i.e., MD oriented the same for both samples in the stack). The first stack is placed on the anvil with the specimen centered underneath the pressure foot. The foot is lowered at 0.03 in/sec to an applied pressure of 95 g/in². The reading is taken after 3 sec., and the foot is raised. The measure is repeated in like fashion for the remaining specimen stack. The caliper is calculated as the average caliper of the two stacks, divided by 2 (since there are 2 specimens per stack), and is reported in mils (0.001 in) to the nearest 0.1 mils.

### Horizontal Full Sheet (HFS) Test Method

The Horizontal Full Sheet (HFS) test method determines the amount of distilled water absorbed and retained by a fibrous structure of the present invention. This method is performed by first weighing a sample of the fibrous structure to be tested (referred to herein as the “dry weight of the sample”), then thoroughly wetting the sample, draining the wetted sample in a horizontal position and then reweighing (referred to herein as “wet weight of the sample”). The absorptive capacity of the sample is then computed as the amount of water retained in units of grams of water absorbed by the sample. When evaluating different fibrous structure samples, the same size of fibrous structure is used for all samples tested.

The apparatus for determining the HFS capacity of fibrous structures comprises the following:

1) An electronic balance with a sensitivity of at least ±0.01 grams and a minimum capacity of 1200 grams. The balance should be positioned on a balance table and slab to minimize the vibration effects of floor/benchtop weighing. The balance should also have a special balance pan to be able to handle the size of the sample tested. The sample may be the size of a sheet as provided to the consumer (e.g., a fibrous structure sample of about 11 in. (27.9 cm) by 11 in. (27.9 cm)). The balance pan can be made out of a variety of materials. Plexiglass is a common material used.

2) A sample support rack and sample support rack cover is also required. Both the rack and cover are comprised of a lightweight metal frame, strung with 0.012 in. (0.305 cm) diameter monofilament so as to form a grid. The size of the support rack and cover is such that the sample size can be conveniently placed between the two.

The HFS test is performed in an environment maintained at 23±1° C. and 50±2% relative humidity. A water reservoir or tub is filled with distilled water at 23±1 0 C to a depth of 3 inches (7.6 cm).

Eight samples of a fibrous structure to be tested are carefully weighed on the balance to the nearest 0.01 grams. The dry weight of each sample is reported to the nearest 0.01 grams. The empty sample support rack is placed on the balance with the special balance pan described above. The balance is then zeroed (tared). One sample is carefully placed on the sample support rack. The support rack cover is placed on top of the support rack. The sample (now sandwiched between the rack and cover) is submerged in the water reservoir. After the sample is submerged for 60 seconds, the sample support rack and cover are gently raised out of the reservoir.

The sample, support rack and cover are allowed to drain horizontally for 120±5 seconds, taking care not to excessively shake or vibrate the sample. While the sample is draining, the rack cover is carefully removed and all excess water is wiped from the support rack. The wet sample and the support rack are weighed on the previously tared balance. The weight is recorded to the nearest 0.01g. This is the wet weight of the sample.

The gram per fibrous structure sample absorptive capacity of the sample is defined as (wet weight of the sample−dry weight of the sample). The horizontal absorbent capacity (HAC) is defined as: absorbent capacity=(wet weight of the sample−dry weight of the sample)/(dry weight of the sample) and has a unit of gram/gram.

### Vertical Full Sheet (VFS) Test Method

The Vertical Full Sheet (VFS) test method determines the amount of distilled water absorbed and retained by a fibrous structure of the present invention. This method is performed by first weighing a sample of the fibrous structure to be tested (referred to herein as the “dry weight of the sample”), then thoroughly wetting the sample, draining the wetted sample in a vertical position and then reweighing (referred to herein as “wet weight of the sample”). The absorptive capacity of the sample is then computed as the amount of water retained in units of grams of water absorbed by the sample. When evaluating different fibrous structure samples, the same size of fibrous structure is used for all samples tested.

The apparatus for determining the VFS capacity of fibrous structures comprises the following:

1) An electronic balance with a sensitivity of at least ±0.01 grams and a minimum capacity of 1200 grams. The balance should be positioned on a balance table and slab to minimize the vibration effects of floor benchtop weighing. The balance should also have a special balance pan to be able to handle the size of the sample tested (i.e.; a fibrous structure sample of about 11 in. (27.9 cm) by 11 in. (27.9 cm)). The balance pan can be made out of a variety of materials. Plexiglass is a common material used.

2) A sample support rack and sample support rack cover is also required. Both the rack and cover are comprised of a lightweight metal frame, strung with 0.012 in. (0.305 cm) diameter monofilament so as to form a grid. The size of the support rack and cover is such that the sample size can be conveniently placed between the two.

The VFS test is performed in an environment maintained at 23±1° C. and 50±2% relative humidity. A water reservoir or tub is filled with distilled water at 23 ±1 0 C to a depth of 3 inches (7.6 cm).

Eight 19.05 cm (7.5 inch)×19.05 cm (7.5 inch) to 27.94 cm (11 inch) x 27.94 cm (11 inch) samples of a fibrous structure to be tested are carefully weighed on the balance to the nearest 0.01 grams. The dry weight of each sample is reported to the nearest 0.01 grams. The empty sample support rack is placed on the balance with the special balance pan described above. The balance is then zeroed (tared). One sample is carefully placed on the sample support rack. The support rack cover is placed on top of the support rack. The sample (now sandwiched between the rack and cover) is submerged in the water reservoir. After the sample is submerged for 60 seconds, the sample support rack and cover are gently raised out of the reservoir.

The sample, support rack and cover are allowed to drain vertically for 60±5 seconds, taking care not to excessively shake or vibrate the sample. While the sample is draining, the rack cover is carefully removed and all excess water is wiped from the support rack. The wet sample and the support rack are weighed on the previously tared balance. The weight is recorded to the nearest 0.01 g. This is the wet weight of the sample.

The procedure is repeated for with another sample of the fibrous structure, however, the sample is positioned on the support rack such that the sample is rotated 90° compared to the position of the first sample on the support rack. The gram per fibrous structure sample absorptive capacity of the sample is defined as (wet weight of the sample - dry weight of the sample). The calculated VFS is the average of the absorptive capacities of the two samples of the fibrous structure.

### Capacity Rate Test

Conditioned Room—Temperature is controlled from 73° F.±2° F. (23° C.±1° C.). Relative Humidity is controlled from 50%±2%

Sample Preparation—Product samples are cut using hydraulic/pneumatic precision cutter into 3.375 inch diameter circles.

Capacity Rate Tester (CRT)—The CRT is an absorbency tester capable of measuring capacity and rate. The CRT consists of a balance (0.001 g), on which rests on a woven grid (using nylon monofilament line having a 0.014 diameter) placed over a small reservoir with a delivery tube in the center. This reservoir is filled by the action of solenoid valves, which help to connect the sample supply reservoir to an intermediate reservoir, the water level of which is monitored by an optical sensor. The CRT is run with2amm water column, controlled by adjusting the height of water in the supply reservoir.

Software—LabView based custom software specific to CRT Version 4.2 or later.

Water—Distilled water with conductivity <100/cm (target <5 μS/cm) @25° C.

Sample Preparation—For this method, a usable unit is described as one finished product unit regardless of the number of plies. Condition all samples with packaging materials removed for a minimum of 2 hours prior to testing. Discard at least the first ten usable units from the roll. Remove two usable units and cut one 3.0-inch circular sample from the center of each usable unit for a total of 2 replicates for each test result. Do not test samples with defects such as wrinkles, tears, holes, etc. Replace with another usable unit which is free of such defects.

### Sample Testing Pre-Test Set-Up

1. The water height in the reservoir tank is set—2.0 mm below the top of the support rack (where the towel sample will be placed).
2. The supply tube (8 mm I.D.) is centered with respect to the support net.
3. Test samples are cut into circles of 3″ diameter and equilibrated at Tappi environment conditions for a minimum of 2 hours.

### Test Description

1. After pressing the start button on the software application, the supply tube moves to 0.33 mm below the water height in the reserve tank. This creates a small meniscus of water above the supply tube to ensure test initiation. A valve between the tank and the supply tube closes, and the scale is zeroed.
2. The software prompts you to “load a sample”. A sample is placed on the support net, centering it over the supply tube, and with the side facing the outside of the roll placed downward.
3. Close the balance windows, and press the “OK” button—the software records the dry weight of the sample.
4. The software prompts you to “place cover on sample”. The plastic cover is placed on top of the sample, on top of the support net. The plastic cover has a center pin (which is flush with the outside rim) to ensure that the sample is in the proper position to establish hydraulic connection. Optionally, four other pins, 1 mm shorter in depth, are positioned 1.25-1.5 inches radially away from the center pin to ensure the sample is flat during the test. The sample cover rim should not contact the sheet. Close the top balance window and click “OK”.
5. The software re-zeroes the scale and then moves the supply tube towards the sample. When the supply tube reaches its destination, which is 0.33 mm below the support net, the valve opens (i.e., the valve between the reserve tank and the supply tube), and hydraulic connection is established between the supply tube and the sample. Data acquisition occurs at a rate of 5 Hz, and is started about 0.4 seconds before water contacts the sample.
6. The test runs until the instrument measures the rate of uptake to be less than 1.5 mg/sec. Specifically, the instrument keeps a running tally of the amount of fluid taken up by the sample. When the amount of fluid taken up over the last 6 seconds is less than 9 mg, the test terminates. The supply tube pulls away from the sample to break the hydraulic connection.
7. The software records the weight on the scale. This weight represents only the amount of water taken up by the sample.
8. The wet sample is removed from the support net. Residual water on the support net and cover are dried with a paper towel.
9. Repeat until all samples are tested.
10. After each test is run, a *.txt file is created (typically stored in the CRT/data/rate directory) with a file name as typed at the start of the test. The file contains all the test set-up parameters, dry sample weight, and cumulative water absorbed (g) vs. time (sec) data collected from the test. The CRT value is calculated by dividing the weight of water absorbed (as recorded at the end of the test) by the weight of the dry sample taken in step 3. The units of CRT value are g/g.

### Gloss Test Method

This Gloss Test Method is used to measure the loss of gloss of a tile surface with soil/cleaning medium residue compared to a pristine tile.

### Materials and Instruments

3-1000 mL Glass Beakers

A Control pulp-containing fibrous structure, such as a 2-ply paper towel—void of surfactant paste composition and aqueous solution of surfactants

10 inch×12 inch Black Ceramic Enamel coated tiles (commercially available from The

Shop Tile, Sharonville, Ohio) or black glossy sphinx ceramic tiles (20 cm×25 cm) Ref. H07300 commercially available from Carobati, Aartselaar, Belgium or equivalent tile×6

Distilled Water

70/30 water/propanol solution

10 cm×12 cm plastic plastering float with handle

Lard—commercially available from Kroger, Cincinnati, Ohio.

Crisco® Vegetable Oil commercially available from The J.M. Smucker Company, Orrville, Ohio.

1 mL plastic syringe

Kimwipes™ commercially available from Kimberly Clark, Dallas, Tex.

Glossy meter with 3 angle capability commercially available from BYK Gardner, Columbia, Md., or equivalent gloss meter

Analytical balance

Hair dryer

### Sample Preparation (1% Surfactant Composition)

For each surfactant composition to be tested, make up a 1% surfactant composition (aqueous surfactant solution or surfactant paste composition) as follows: weigh 10 g of the aqueous surfactant solution and pour in a 1000 mL beaker containing approx. 900 mL of distilled water, after the 10 g of aqueous surfactant solution is added, bring the beaker volume to 1000 mL with additional distilled water and then stir gently for 1 minute.

### Tiles Ppreparation and Cleaning

Rinse each tile with tap water for 30 seconds or until all visible dirt/soil is removed, then clean with excess distilled water. Next spray the tile with the 70/30 water/propanol solution until the whole tile is covered with the solution. Remove the remnant 70/30 water/propanol with Kimwipes and finally dry the tile with a hair dryer. Repeat this procedure once to produce a pristine tile. If a tile has any smudges or other defects or cracks, discard and use another new tile and follow the same procedure to produce a pristine tile.

### Control Fibrous Structure

Take a sheet of fibrous structure fold it twice to get a quarter of the initial surface, fold it with any emboss side out.

### Residue Remaining from Surfactant Compositions

Dip the folded sheet in the 1000 mL beaker containing a 1% surfactant composition to be tested. Soak the folded sheet in the 1% surfactant composition to fully saturate the sheet. Remove the saturated sheet from the beaker and gently press the folded sheet to squeeze out the 1% surfactant composition until the total weight of the soaked sheet weighs about 10 g. Next, place the wet folded sheet on a dry clean tile and press it gently with the plastering float. The sheet and the plastering float must be positioned in the center top of the tile. Slowly pull the plastering float from its handle (a pressure of about 300 g/100 cm² is applied as a result of the plastering float and pulling the plastering float) along the tile until the edge of the float reaches the end of the tile. Repeat the same movement one more time in the opposite direction and then from top to bottom again. Lift the float and folded sheet. Dry the tile with the hair dryer until tile is visibly dry. Place the gloss meter at 3 positions along the tile: one at 5 cm from the top, one in the center and the last at 10 cm from the bottom and record the gloss values (20°, 60°, and 80° incidence angles) at all three positions. Repeat this test again with another pristine tile to obtain 3 more gloss values. The average of the 6 gloss values is reported as the Gloss Value for the surfactant composition.

### Cleaning Performance

The cleaning performance (hence soil left behind) is measured using the pristine tiles described above as the control tiles. A gloss value of a pristine tile is measured by placing the gloss meter at 3 positions along the tile: one at 5 cm from the top, one right at the middle and the last at 10 cm from the bottom and record the gloss values at all three positions. Repeat this test again with another pristine tile to obtain 3 more gloss values. The average of the 6 gloss values is reported as the Gloss Value (20°, 60°, and 80° incidence angles) for the control tile.

A pristine tile is then soiled with 100 mg of Crisco® vegetable oil in the center and 5 cm from top—position of the tile using a plastic syringe. Swipe with the wet folded sheet and plastering float, clean, and dry the tile as described above. Place the gloss meter at 3 positions along the tile: one at 5 cm from the top, at the center and the last at 10 cm from the bottom and record the gloss values (20°, 60°, and 80° incidence angles) at all three positions. Repeat this test again with another pristine tile to obtain 3 more gloss values. The average of the 6 gloss values is reported as the Gloss Values (20°, 60°, and 80° incidence angles) for the surfactant composition.

A pristine tile is then soiled with 100 mg of lard in the center and 5 cm from top—position of the tile using a plastic syringe. Swipe with the wet folded sheet and plastering float, clean, and dry the tile as described above with a 1% surfactant composition wet folded sheet as described above. Place the gloss meter at 3 positions along the tile: one at 5 cm from the top, at the center and the last at 10 cm from the bottom and record the gloss values (20°, 60°, and 80° incidence angles) at all three positions. Repeat this test again with another pristine tile to obtain 3 more gloss values. The average of the 6 gloss values is reported as the Gloss Values (20°, 60°, and 80° incidence angles) for the surfactant composition.

### Crystallinity Test Method

The crystallinity of a surfactant composition (aqueous solution of surfactants or a surfactant paste composition), 100 μL of the surfactant composition (33.3 parts surfactant composition and 66.7 parts distilled water) to be tested is added to a glass microscope slide. The slide is left to rest at 25° C. for 7 days to dry and permit any crystallizatine arrangement to occur. A cover slide is then added to the glass microscope slide to sandwich the dried surfactant composition between the glass microscope slide and the cover slide. A standard optical microscope (Nikon 516096 or equivalent) with a 0-360° rotational angle polarizer (Nikon Phase Contrast T-2 15957 or equivalent) was then used to view the surfactant composition. This crystallinity test method identifies surfactant compositions based on type and amount of crystallinity, for example crystal aggregation versus no crystal aggregation, birefringence versus no birefringence.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A surfactant paste composition comprising one or more surfactants, wherein the surfactant paste composition exhibits one or more of the following properties:
a. a viscosity of less than 1000 cps;
b. less than 30% by weight of the surfactant paste composition of free water;
c. a non-random crystal pattern;
d. no birefringence as measured according to the Crystallinity Test Method; and
e. combinations thereof.

2. The surfactant paste composition of claim 1 wherein the surfactant paste composition comprises about 10% or more by weight of a non-water viscosity reducing agent.

3. The surfactant paste composition according to claim 1 wherein at least one of the surfactants is selected from the group consisting of: anionic surfactants, amphoteric surfactants, and mixtures thereof.

4. The surfactant paste composition according to claim 3 wherein the anionic surfactant comprises an alkyl ethoxy sulfate.

5. The surfactant paste composition according to claim 3 wherein the amphoteric surfactant comprises amine oxide.

6. The surfactant paste composition according to claim 1 wherein the surfactants comprise an anionic surfactant and an amphoteric surfactant at a weight ratio of anionic surfactant to amphoteric surfactant of at least 1:1.

7. A dry-to-the touch fibrous structure comprising a surfactant paste composition according to claim 1.

8. The fibrous structure according to claim 7 wherein the fibrous structure exhibits a Suds Retention Value of less than 70% as measured according to the Suds Volume Test Method.

9. The fibrous structure according to claim 8 wherein the fibrous structure exhibits a Suds Retention Value of less than 55% as measured according to the Suds Volume Test Method.

10. The fibrous structure according to claim 7 wherein the fibrous structure is a multi-ply fibrous structure.

11. The fibrous structure according to claim 7 wherein the fibrous structure comprises about 15% or less by weight of the surfactant paste composition.

12. The fibrous structure according to claim 7 wherein the fibrous structure further comprises a plurality of filaments.

13. The fibrous structure according to claim 12 wherein at least one of the filaments comprises a coloring agent.

14. The fibrous structure according to claim 7 wherein the fibrous structure further comprises a plurality of pulp fibers.

15. The fibrous structure according to claim 7 wherein the fibrous structure exhibits an Initial Suds Volume of greater than about 40 mL as measured according to the Suds Volume Test Method.

16. The fibrous structure according to claim 15 wherein the fibrous structure exhibits an Initial Suds Volume of greater than about 60 mL.

17. The fibrous structure according to claim 7 wherein the fibrous structure comprises greater than about 3 gsm of the surfactants.

18. A method for making a dry-to-the-touch fibrous structure wherein the method comprises the steps of:
a. providing a surfactant paste composition according to claim 1; and
b. applying the surfactant paste composition to a fibrous structure to form a dry-to-the-touch fibrous structure.

19. A method for making a surfactant paste composition according to claim 1 wherein the method comprises the steps of:
a. providing a surfactant paste comprising one or more surfactants; and
b. adding to the surfactant paste one or more non-water viscosity reducing agents, such that a surfactant paste composition is formed that exhibits one or more of the following properties:
i. a non-random crystal pattern;
ii. a viscosity of less than 1000 cps;
iii. less than 30% by weight of free water;
iv. no birefringence as measured according to the Crystallinity Test Method; and
v. combinations thereof.

20. A method for making a surfactant paste composition according to claim 1 wherein the method comprises the steps of:
a. providing a surfactant paste comprising one or more surfactants; and
b. adding to the surfactant paste one or more additives selected from the group consisting of:
i. one or more additional surfactants,
ii. one or more non-water viscosity reducing agents; and
iii. mixtures thereof;
such that a surfactant paste composition is formed that exhibits one or more of the following properties:
i. a non-random crystal pattern;
ii. a viscosity of less than 1000 cps;
iii. less than 30% by weight of free water;
iv. no birefringence as measured according to the Crystallinity Test Method; and
v. combinations thereof.
